(19) United States
(12) Patent Application Publication
(10) Pub. No.: US 2008/0223774 A1
(43) Pub. Date: Sep. 18, 2008

(54) Mounting device for a filter

(76) Inventors: Po-Huei Chen, Fenyuan Hsiang (TW); Jack Lee, Dali City (TW)

Correspondence Address: JACKSON WALKER, L.L.P., 112 E. PECAN, SUITE 2400, SAN ANTONIO, TX, 78205, US

(21) Appl. No.: 11/974,867

(22) Filed: Oct. 16, 2007

(30) Foreign Application Priority Data
Mar. 13, 2007 (TW) 096204039

(51) Int. Cl. B01D 35/30; B01D 29/21; B01D 27/08

(52) U.S. Cl. 210/232; 210/443; 210/457; 210/437

(57) ABSTRACT

A mounting device for a filter has a distributor and a connecting member. The distributor has a base and a tube. The base has a top surface, an annular surface, a tube mount formed in the top surface and an outlet formed radially in base and communicating with the tube mount. The tube is mounted in the base, communicates with the tube mount and has a proximal end, a distal end, an outer surface and multiple through holes formed through the outer surface of the tube. The connecting member is mounted on the distal end of the tube and has a sealing segment mounted on the distal end of the tube. Therefore, the mounting device can precisely position a filter element and prevent the filter element from damage.

### BACKGROUND OF THE INVENTION

1. Field of Invention

The present invention relates to a filter, and more particularly to a mounting device for a filter that can precisely position a filter element and prevent the filter element from deforming.

2. Description of the Related Art

A conventional filter is used to filter fluids, such as drinking water, to remove colored and odorous impurities in the fluid. The impurities comprises solid particle, suspended substances, mud, residual chlorine, organic compounds, trihalomethanes, nitrates, metallic ions, dissolved inorganic compounds, pesticides and dioxins and can be removed or absorbed by a filter element of the filter. A common filter element can be filter screen, diatomaceous earth or active carbon having a high porosity and adsorption capacity.

With reference to FIG. 11, a conventional filter comprises a hollow barrel (70) and a solid filter element having an external surface mounted in the barrel (70). The barrel (70) has an internal surface and an inlet and outlet formed through the barrel (70). The fluid is added to the inlet and the filter element removes impurities. However, the filter element must correspond to and precisely fit the barrel (70), or fluid may pass between the inner and outer surfaces and avoid filtration. This is especially true if a fluid at high pressure is applied to the inlet since most fluid will pass between the inner and outer surface.

Therefore, with further reference to FIG. 12, another conventional filter is implemented with a hanging rod (71) and the filter element further comprises a through hole. The hanging rod (71) is mounted longitudinally in the barrel (70) and extends through the through hole of the filter element and holds the filter element in the barrel (70). Fluid passes through the filter and is filtered by the filter element.

However, when the hanging rod (71) does not correspond exactly to the through hole of the filter element, the filter element is not held securely in the barrel (70) and may rotate or vibrate causing damage or deformation to the filter element and reducing filtration efficiency.

Additionally, the filter element may also be damaged or deformed due to fluid pressure being unevenly distributed especially when high pressure is applied to the filter to force the fluid to pass through the filter element.

To overcome the shortcomings, the present invention provides a mounting device for a filter to mitigate or obviate the aforementioned problems.

### SUMMARY OF THE INVENTION

The primary objective of the present invention is to provide a mounting device for a filter that can precisely position a filter element and prevent the filter element from damage.

The mounting device for a filter in accordance with the present invention comprises a distributor and a connecting member. The distributor comprises a baseband a tube. The base has a top surface, an annular surface, a tube mount formed in the top surface and an outlet formed radially in the base and communicating with the tube mount. The tube is mounted in the base, communicates with the tube mount and has a proximal end, a distal end, an outer surface and multiple through holes formed through the outer surface of the tube. The connecting member is mounted on the distal end of the tube and has a sealing segment mounted on the tube. Therefore, the mounting device can precisely position the filter element and prevent the filter element from damage.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a mounting device for a filter in accordance with the present invention;

FIG. 2 is a side view in partial section of the mounting device in FIG. 1;

FIG. 3 is an exploded perspective view of a filter with the mounting device in FIG. 1;

FIG. 4 is a perspective view of the filter in FIG. 3;

FIG. 5 is a perspective view of a second embodiment of a mounting device in accordance with the present invention;

FIG. 6 is a perspective view of a third embodiment of a mounting device in accordance with the present invention;

FIG. 7 is a perspective view of a fourth embodiment of a mounting device in accordance with the present invention;

FIG. 8 is a side view in partial section of a fifth embodiment of a mounting device in accordance with the present invention;

FIG. 9 is a perspective view of a sixth embodiment of a mounting device in accordance with the present invention;

FIG. 10 is a perspective view of a seventh embodiment of a mounting device in accordance with the present invention;

FIG. 11 is a perspective view of a conventional filter in accordance with the prior art; and

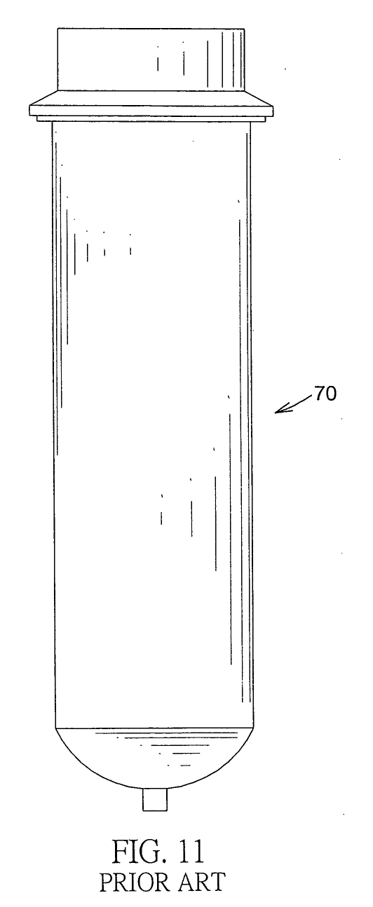

FIG. 12 is a perspective view of another conventional filter in accordance with the prior art.

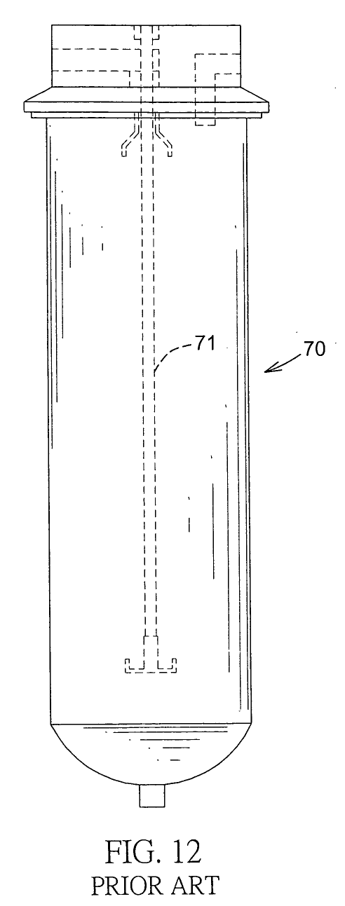

### DETAILED DESCRIPTION OF THE INVENTION

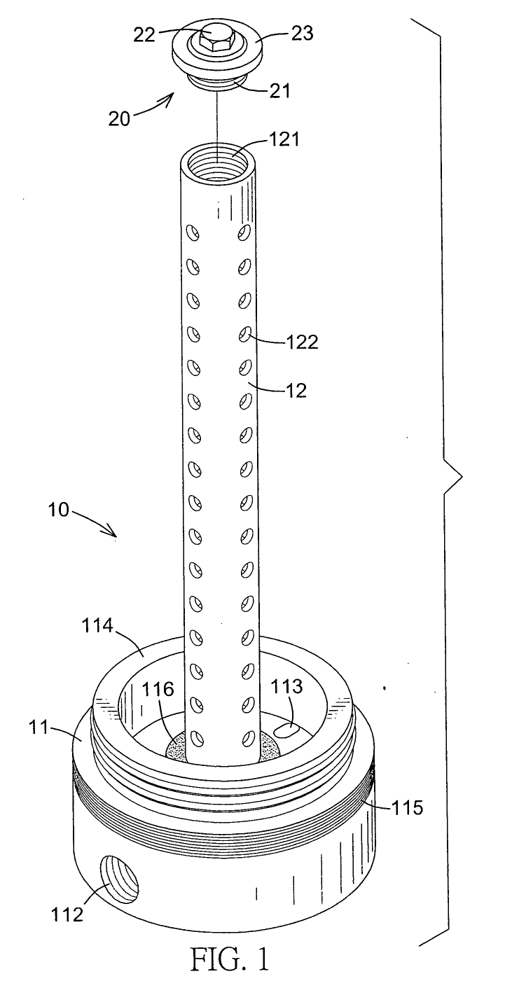

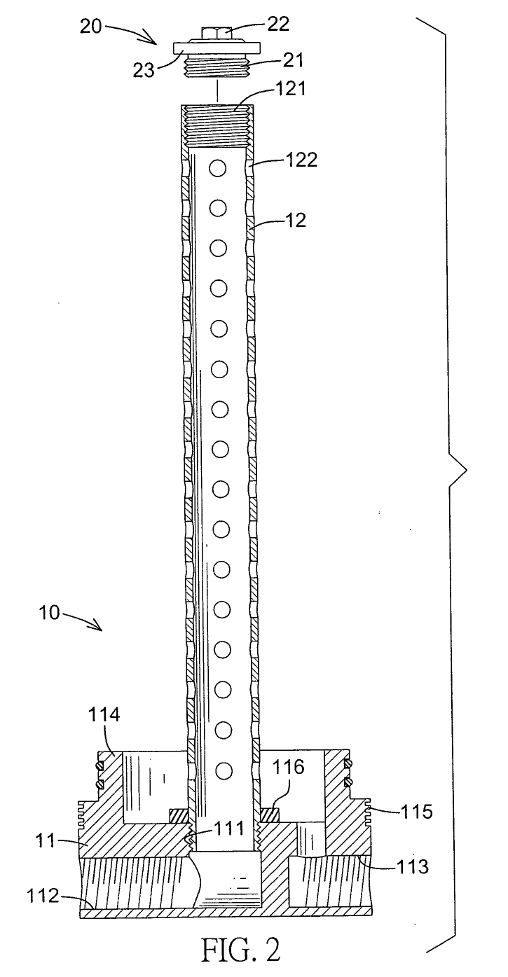

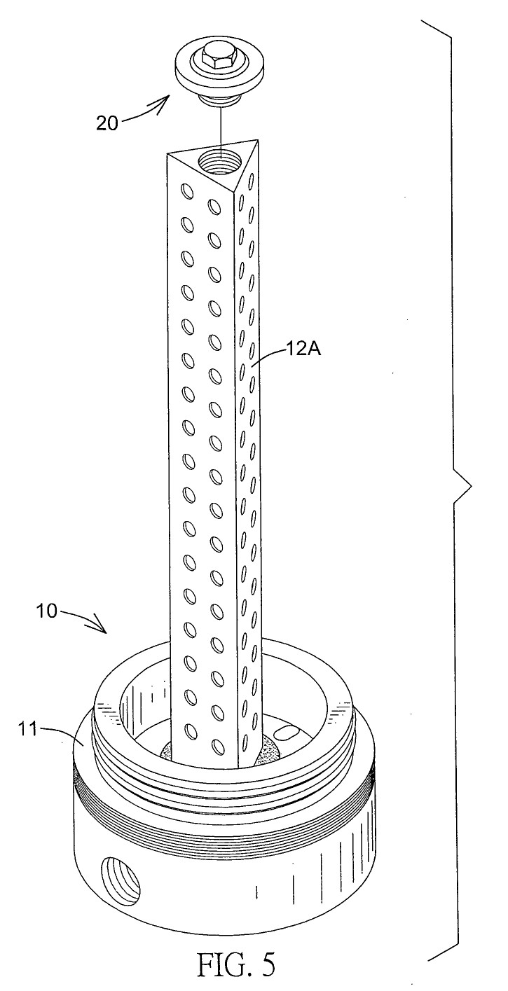

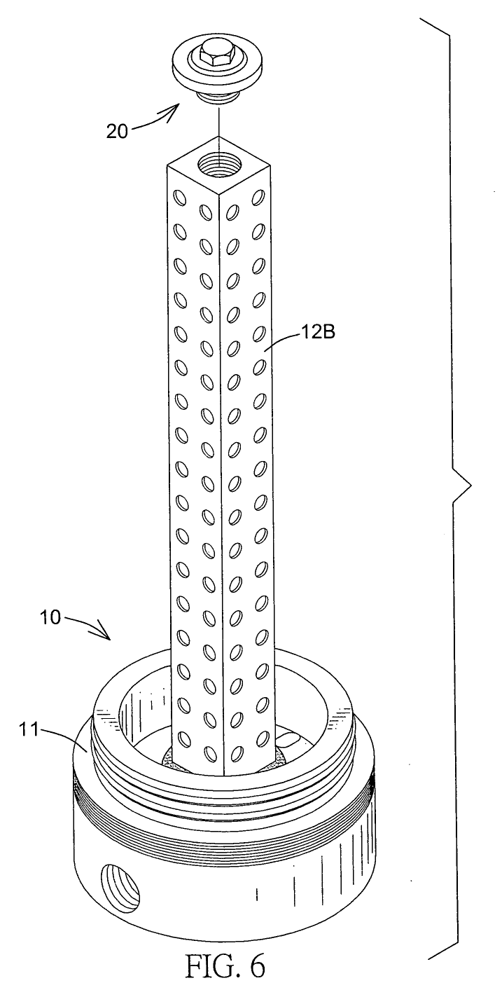

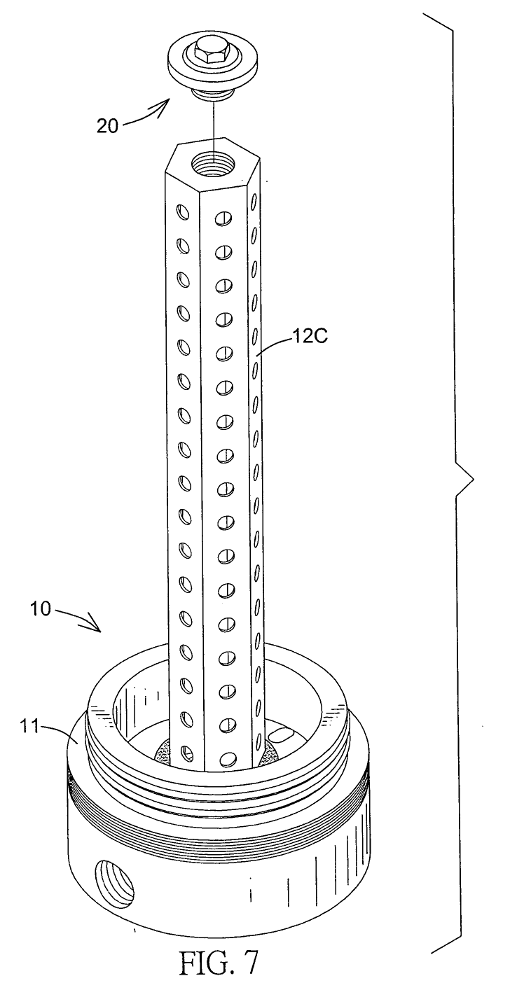

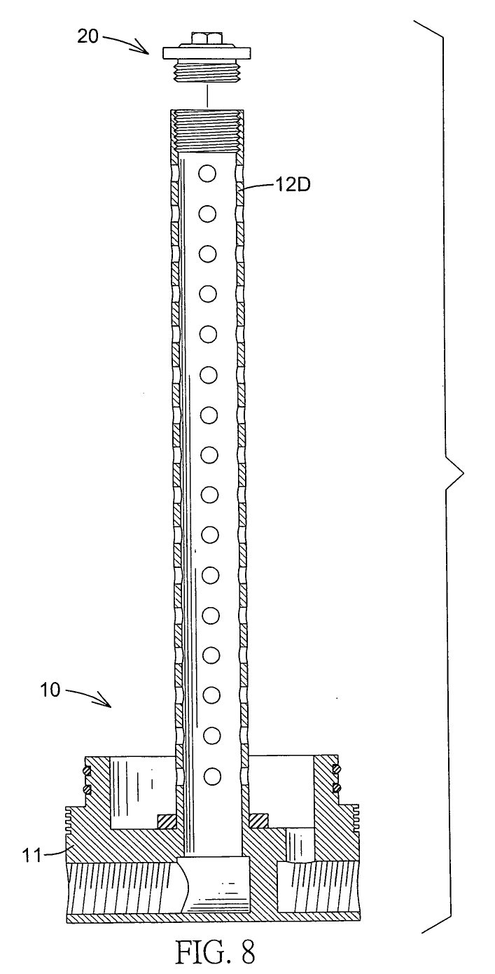

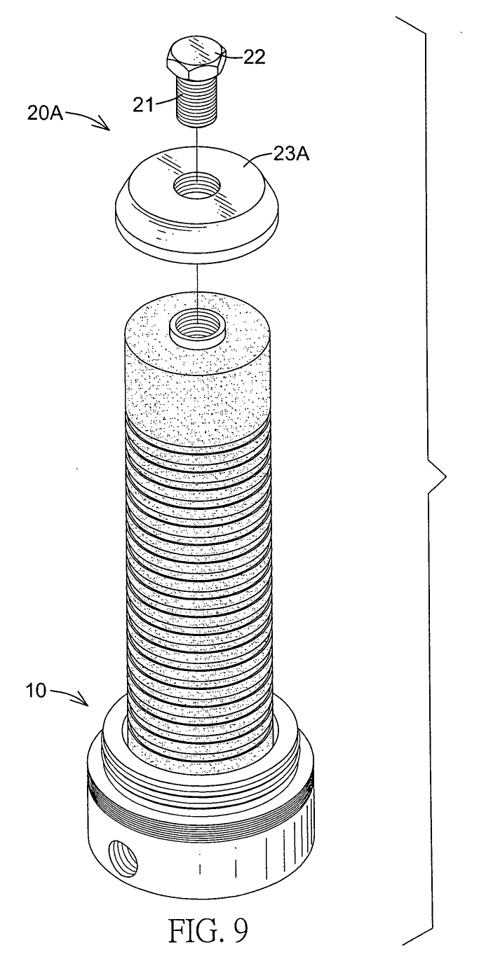

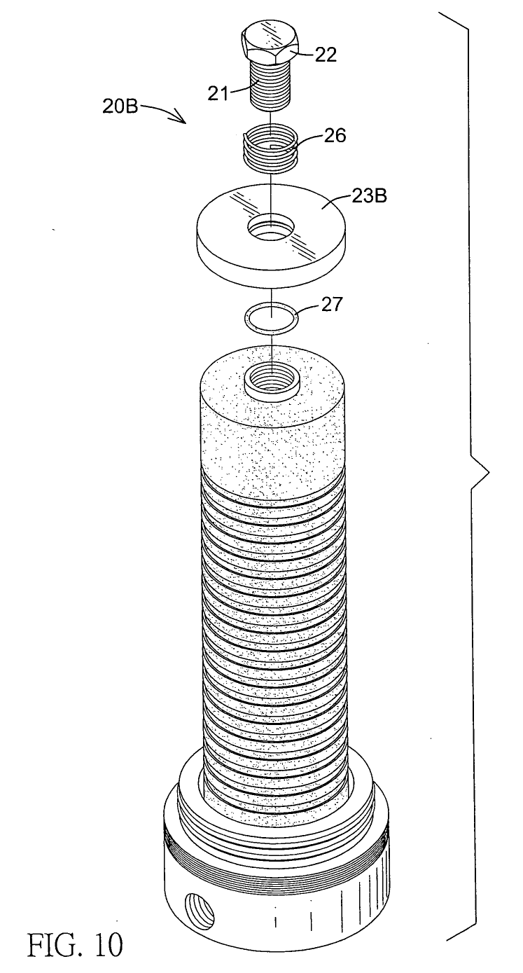

With reference to FIGS. 1, 2, 5, 6, 7, 8, 9 and 10, a mounting device for a filter in accordance with the present invention comprises a distributor (10) and a connecting member (20).

The distributor (10) comprises abase (11) and a tube (12, 12A, 12B, 12C, 12D). The base (11) is a disk and has a top surface, an annular surface, a tube mount (111), an outlet (112) and may comprise an annular seal (114), an inlet (113), at least one gasket, an outer thread (115) and a flange (116).

The top surface of the base (11) has a center. The tube mount (111) is formed in the center of the top surface and may have an inner thread.

The outlet (112) is formed radially in the base (11) and communicates with the tube mount (111).

The annular seal (114) is formed on the top surface of the base (11), is concentric to and larger than the tube mount (111) and has an outer surface and at least one groove formed radially in the outer surface.

The inlet (113) is formed radially in the base (11) and has an opening and does not communicate with the tube mount (111) or the outlet (112), i.e. the inlet (113) is independent of the tube mount (111) and the outlet (112). The opening of the inlet (113) is formed in the top surface of the base (11) and is disposed between the tube mount (111) and the annular seal (114).

Each one of the at least one gasket corresponds to and is mounted in a corresponding groove of the annular seal (114).

The outer thread (115) is formed on the annular surface of the base (11).

The flange (116) is formed on the top surface of the base (11) around the tube mount (111) within the annular seal (114).

The tube (12, 12A, 12B, 12C, 12D) attaches to the base (11) and communicates with the tube mount (111) and has a proximal end, a distal end, an outer surface, an optional outer thread, an optional inner thread (121) and multiple through holes (122). The tube (12, 12A, 12B, 12C, 12D) may be a circular tube (12), triangular tube (12A), quadrangular tube (12B) or hexagonal tube (12C). The tube (12) may be mounted in the base (11) or the tube (12D) may be formed integrally from the base (11). The outer thread is formed on the proximal end of the tube (12, 12A, 12B, 12C, 12D), corresponds to and engages the inner thread of the tube mount (111) in the base (11). The inner thread (121) is formed on the distal end of the tube (12, 12A, 12B, 12C, 12D). The through holes (122) are formed radially through the outer surface of the tube (12, 12A, 12B, 12C, 12D) to allow fluid to flow into the tube (12, 12A, 12B, 12C, 12D) through the through holes (122).

The connecting member (20, 20A, 20B) is mounted on the distal end of the tube (12, 12A, 12B, 12C, 12D) and has a proximal end, a distal end, a sealing segment (23, 23A, 23B), an optional outer thread (21), an optional head (22), an optional spring (26) and an optional washer (27). The sealing segment (23, 23A, 23B) is mounted on the distal end of the tube (12, 12A, 12B, 12C, 12D). The outer thread (21) is formed on the proximal end of the connecting member (20) and corresponds to and engages the inner thread (121) of the tube (12, 12A, 12B, 12C, 12D). The head (22) is formed on the distal end of the connecting member (20) corresponds to and can be rotated by a tool. The spring (26) is mounted on the proximal end of the connecting member (20B) and presses the sealing segment (23B) against the tube (12, 12A, 12B, 12C, 12D). The washer (27) is mounted between the sealing segment (23B) and the distal end of the tube (12, 12A, 12B, 12C, 12D) to prevent fluid leakage.

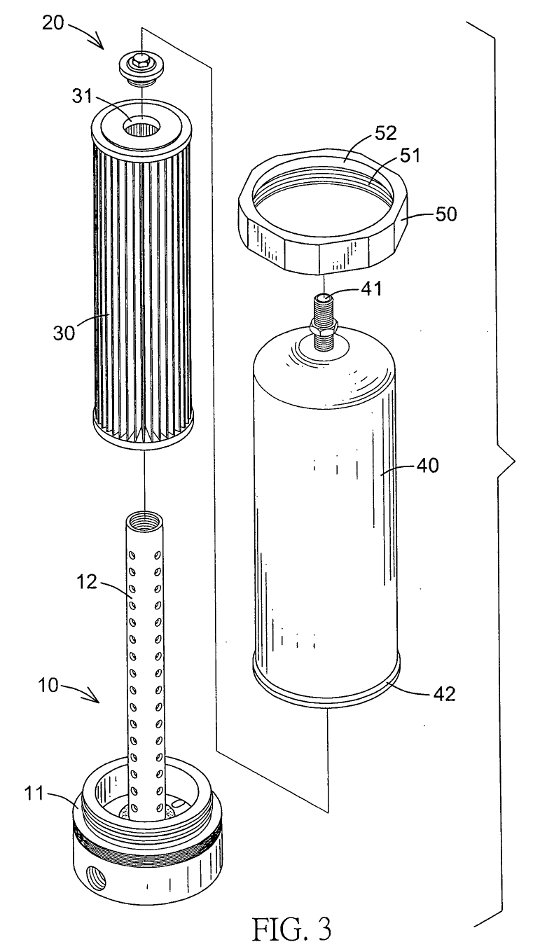

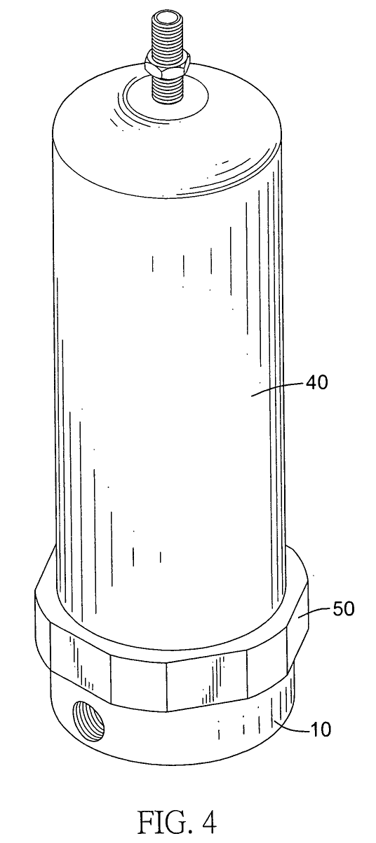

With further reference to FIGS. 3 and 4, a filter comprises the mounting device as described, a filter element (30), a barrel (40) and a connecting ring (50). The filter element (30) is mounted on the base (11) and around the connecting member (20) and has two ends, a through hole (31) and two washers. The through hole (31) is formed longitudinally through the filter element (30) and is mounted tightly around the tube (112). The washers are formed respectively on the ends of the filter element (30). One washer engages the flange (116) on the base (11) and another washer engages the sealing segment (23) of the connecting member (20). The barrel (40) is cylindrical and is mounted on the annular seal (114) of the base (11) to cover the filter element (30) and has a distal end, a release valve (41) and may comprise a fluid inlet. The releases valve (41) is formed through the distal end of the barrel (40) to regulate pressure. The fluid inlet is formed through the barrel (40). The connecting ring (50) is mounted on the base (11) tightly holds the barrel (40) and the base (11) together.

Fluid enters the filter through the inlet (113) or the fluid inlet and passes through the filter element (30) in the barrel (40). Then fluid flows into the tube (12) through the through holes (122) of the tube (12) and flows out through the outlet (112) of the base (11) to achieve filtration of fluid.

Because the tube (12) matches the filter element (30) well, the filter element (30) will not be damaged due to rotation or vibration and even when high pressure is applied on the filter element (30) fluid pressure is evenly distributed around the filter element (30) to prevent damage. Therefore, the mounting device improves filtration efficiency.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A mounting device for a filter comprising
a distributor comprising comprises
a base having
a top surface having a center;
an annular surface;
a tube mount being formed in the center of the top surface; and
an outlet being formed radially in the annular surface and communicating with the tube mount; and
a tube attaching to the base, communicating with the tube mount and having
a proximal end;
a distal end;
an outer surface; and
multiple through holes being formed radially through the outer surface of the tube; and
a connecting member being mounted on the distal end of the tube and having
a proximal end;
a distal end; and
a sealing segment being mounted on the distal end of the tube.

2. The mounting device for a filter as claimed in claim 1, wherein
the tube further has an inner thread formed on the distal end of the tube; and
the connecting member further has an outer thread formed on the proximal end of the connecting member and corresponding to and engaging the inner thread of the tube.

3. The mounting device for a filter as claimed in claim 2, wherein
the base further has a flange formed on the top surface of the base around the tube mount.

4. The mounting device for a filter as claimed in claim 3, wherein
the base further has an inlet formed radially in the base and having an opening in the top surface of the base, wherein the opening of the inlet is dependent of the tube mount and the outlet.

5. The mounting device for a filter as claimed in claim 4, wherein
the base further has an annular seal formed on the top surface of the base concentric to and larger than the tube mount; and
the opening of the inlet is disposed between the tube mount and the annular seal.

6. The mounting device for a filter as claimed in claim 5, wherein
the tube mount of the base further has an inner thread; and
the tube further has an outer thread formed on the proximal end of the tube and corresponding to and engaging the inner thread of the tube mount in the base.

7. The mounting device for a filter as claimed in claim 2, wherein
the tube is formed integrally from the base.

8. The mounting device for a filter as claimed in claim 7, wherein
the base further has a flange formed on the top surface of the base around the tube mount.

9. The mounting device for a filter as claimed in claim 8, wherein
the base further has an inlet formed radially in the base and having an opening in the top surface of the base, wherein the opening of the inlet is dependent of the tube mount and the outlet.

10. The mounting device for a filter as claimed in claim 9, wherein
the base further has an annular seal formed on the top surface of the base concentric to and larger than the tube mount; and
the opening of the inlet is disposed between the tube mount and the annular seal.

11. The mounting device for a filter as claimed in claim 1, wherein
the tube is formed integrally on the base.

12. The mounting device for a filter as claimed in claim 1, wherein
the base further has a flange formed on the top surface of the base around the tube mount.

13. The mounting device for a filter as claimed in claim 12, wherein
the base further has an inlet formed radially in the annular base and having an opening in the top surface of the base, wherein the opening of the inlet is dependent of the tube mount and the outlet.

14. The mounting device for a filter as claimed in claim 13, wherein
the base further has an annular seal formed on the top surface of the base concentric to and larger than the tube mount; and
the opening of the inlet is disposed between the tube mount and the annular seal.

15. The mounting device for a filter as claimed in claim 1, wherein
the tube mount of the base further has an inner thread; and
the tube further has an outer thread formed on the proximal end of the tube corresponding to and engaging the inner thread of the tube mount in the base.
